(19) United States
(12) Patent Application Publication
(10) Pub. No.: US 2008/0008254 A1
(43) Pub. Date: Jan. 10, 2008

(54) Powerline apparatus

(76) Inventors: Chia-Hsian Lin, Taichung City (TW); Chia-Long Sung, Dongshih Township (TW); Wen-Tai Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/790,510

(22) Filed: Apr. 26, 2007

(30) Foreign Application Priority Data
Jul. 7, 2006 (TW) 95212027

(51) Int. Cl. H04M 11/04

(52) U.S. Cl. 375/258

(57) ABSTRACT

This invention discloses a powerline apparatus, and the powerline apparatus includes a powerline network device, which connects with a computer system by a power outlet, and a data-powerline converter, which is connected with the computer system for converting the powerline signal to a network signal. The powerline network device uses a power transmission unit to supply the computer system with power, a signal-line set to transmit/receive the powerline signal to/from the data-powerline converter connected to the computer system, a transmission interface to connect the signal with the power line, and a coupling circuit to extract the powerline signal from/to the power line and couple to the data-powerline converter.

### BACKGROUND OF THE INVENTION

1. Field of the Invention

This invention relates to a powerline network apparatus, more especially, which is an internal powerline network apparatus.

2. Background of the Related Art

For the widespread personal computer application and the rapid internet development, to enhance the space utility for the computer system is a new topic. It is caused by the increasing amount of computer systems in space and the getting more chaos in wires used by the computer systems as the new internet era explodes. In market, the wireless network and the homeplug have been developed to reduce the chaos for the esthetic.

In homeplug technology, the Ethernet signal is converted into the powerline signal, and then transmitted on the power line of a building. Thus, to utilize the original power lines to construct the network will reduce the chaos in computer wires and solve the insufficient network port problem.

A conventional external powerline network architect is shown in FIG. 1. As shown in the figure, a computer system 16 includes a power source unit 162 with a power socket 1620 connected to a wire 13, which is connected to a power line 10, to supply the computer system 16 with power. A network unit 164 (usually, it is a network interface card) of the computer system 16 is necessary to connect with an external powerline converter 18 (PLC). The powerline converter 18 includes a power source unit 182, which is connected to power line 10 via a wire 12 for supplying the powerline converter 18 with power and transforming the voltage of the power line 10 to a proper voltage. And, the powerline converter 18 extracts the network signal from signal on the power line 10 and then sends the network signal to the network unit 164 of the computer system 16 via a network wire 14. However, for constructing the homeplug network system there needs two power source units 162, 182 for the computer system 16 and the powerline converter 18 respectively. Moreover, in general, an external powerline converter 18 is designed to satisfy the safety certification, to dissipate the heat well and to have a beautiful protective shell, so the external powerline converter 18 costs much. Except for the above mentioned, each country asks for a safety certification to cost more. It is a big burden for the homeplug system/product provider.

An internal powerline converter has been developed. As shown in FIG. 2, an internal powerline converter 18′ is integrated into a computer system 16′ with a power source unit 162′, and the computer system 16′ will supply the internal powerline converter 18′ with power to save a power source unit. The internal powerline converter 18′ is connected to the power line 10′ via a wire 12′, extracts the powerline signal from the powerline 10′, uses a analog-to-digital converter 181′ (A/D converter) to transform the alternative current voltage on the power line 10′, about 110˜240 alternative current volts, to a digital level voltage, and converts the digital level voltage to a network signal for the computer system 16′. However, it is dangerous to expose the user to the high voltage risk due to the possibility of plugging/unplugging the wire 12′ carelessly.

There are another internal powerline network apparatus built in the power source unit reduces the cost and volume of its structure (Ref. U.S. Pat. Nos. 6,373,377, 6,972,688 and 6,989,734). However, the power source unit also generates the noises to cause built-in powerline network apparatus in poor performance except for adding a metallic shell cover the internal powerline network apparatus for shielding. Besides, each safety certification for each country will increase the cost of manufacturing and will delay the time to enter the market. Moreover, the user cannot construct the homeplug application by using the existed power source unit of a computer. The user has to exchange the original power source unit to this type of new and expensive power source unit with a built-in powerline converter, and it will cost the user much.

### SUMMARY OF THE INVENTION

For solving the aforementioned problems, one of objects according to this invention provides an internal data-powerline converter built in a computer system, and it will share the power source unit of the computer system to save one power source unit. Thus, the cost of the product can be reduced.

One of objects according to this invention provides an internal data-powerline converter built in a computer system to save a network interface card and the network wire to reduce the cost of constructing the homeplug.

One of objects according to this invention provides an internal data-powerline converter built in a computer system to reduce the cost of designing and manufacturing the shell of an external data-powerline converter so as to improve the market competition.

One of objects according to this invention provides an internal data-powerline converter, which uses a coupling circuit to extract the powerline signal and sends the signal to the data-powerline converter to convert the powerline signal to a network signal to simplify the procedure of signal transformation.

According to an embodiment of this invention, a powerline network apparatus includes a powerline network device and a data-powerline converter configured to be connected with a computer system. The powerline network device includes a coupling circuit, a transmission interface connected to the coupling circuit to connect a powerline signal, a power transmission unit connected to the coupling circuit and a signal-line set electrically connected to the coupling circuit. The power transmission unit receives the power from the power line and supplies the computer system with power. And, the signal-line set is connected to the data-powerline converter to provide the data-powerline converter the powerline signal, extracted from the power line, or to transmit the powerline signal, received from the data-powerline converter, to the power line.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating a conventional external powerline apparatus;

FIG. 2 is a schematic diagram illustrating a conventional internal powerline apparatus;

FIG. 3 is a schematic diagram illustrating an internal powerline apparatus according to an embodiment of this invention;

FIG. 4 is a schematic diagram illustrating a powerline network device according to an embodiment of this invention;

FIG. 5a is a powerline signal transmitting in the power line in a building;

FIG. 5b is a power signal extracted from the powerline signal; and

FIG. 5c is a network signal extracted from the powerline signal.

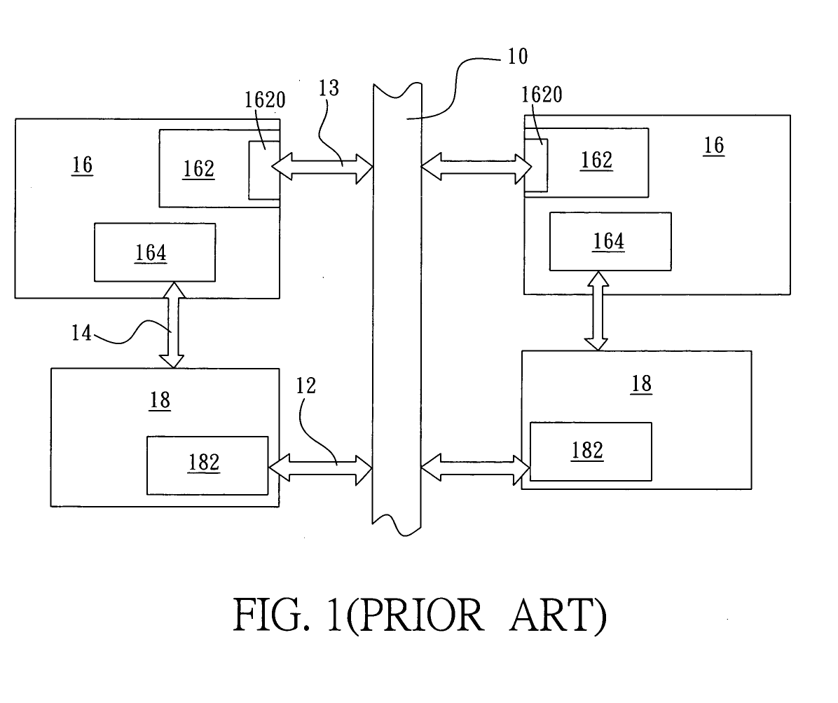

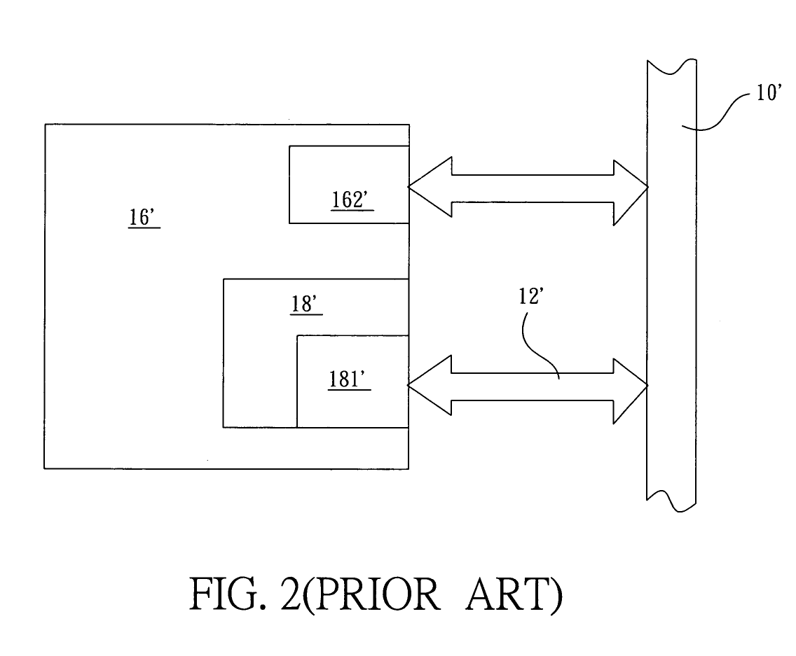

### DETAILED DESCRIPTION OF THE INVENTION

The following description employs some internal powerline devices according to the better embodiments of this invention for illustrating the spirit of this invention.

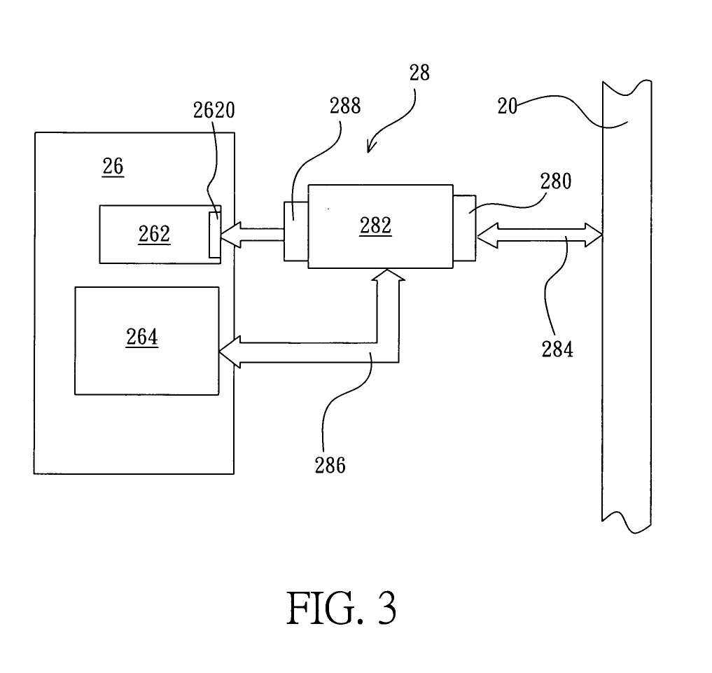

An internal powerline apparatus according to this invention is sketched in FIG. 3 and explained as following. The powerline apparatus includes a powerline network device 28 and a data-powerline converter 264 built in a computer system 26. The powerline network device 28 includes a coupling circuit 282; a transmission interface 280, which is configured in the powerline network device 28 and connected with the coupling circuit 282 and the power line 20 via a wire 284 to receive the power for computer system 26 and transmit/receive the powerline signal on the power line 20; a power transmission unit 288, which is configured in the powerline network device 28 and connected with the coupling circuit 282 and a socket 2620 of a power source unit 262 of the computer system 26 for supplying the computer system 26 with power; and a signal-line set 286, which is configured in the powerline network device 28 and connected with the coupling circuit 282 and the computer system 26. The data-powerline converter 264 is built in the computer system 26 and is connected to the signal-line set 286 for transmitting and receiving the powerline signal between the powerline network device 28 and the computer system 26. The transmission interface 280 should be designed as a power socket (same as computer system's power socket 2620), the wire 284 as an ordinary power cord, and the power transmission unit 288 as an outlet or a wire-added outlet.

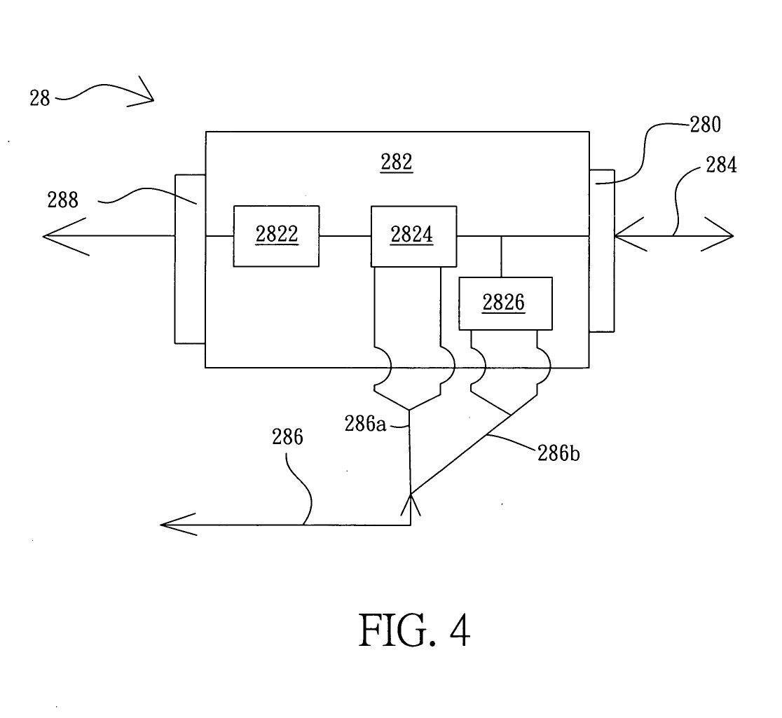

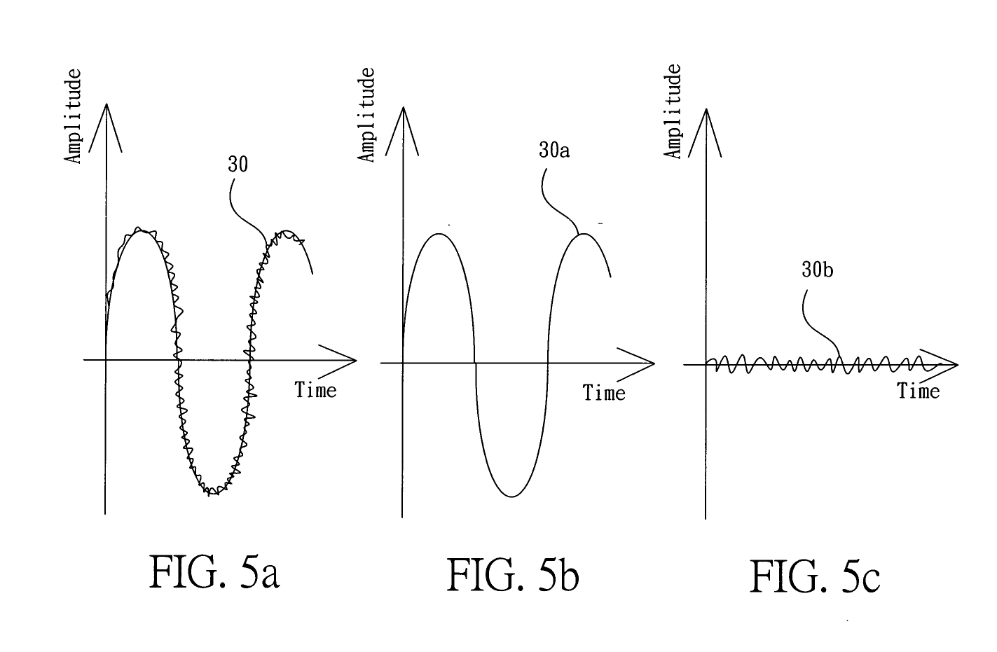

As shown in FIG. 3 and FIG. 4, the powerline network device 28 is sketched. The coupling circuit 282 of the powerline network device 28 is implemented as a coupling transformer 2824, which isolates the high voltage on the power line 20, about 110 to 240 volts, and couples the low-voltage powerline signal to/from the data-powerline converter 264. In one embodiment, the coupling circuit 282 further includes a detecting circuit 2826, which is connected to the transmission interface 280 to detect the polarity of the electrical power in the power line 20, and a noise filter circuit 2822, which is connected to the power transmission unit 288 to filter the noises from the computer system 26 to avoid affecting the signals of the data-powerline converter 264. The signal-line set 286 includes at least a twisted pair 286a extended from the coupling transformer 2824, and further, it can be understood, another twisted pair 286b extended from the detecting circuit 2826 can be included. Referring to the FIG. 3 and FIG. 4 continuously, in this embodiment, for the homeplug, the powerline signal is transmitted in the power line 20. The user matches one end of the wire 284 used originally by the computer system 26 up with the transmission interface 280, and plugs another end into the original outlet of the building to connect the powerline network device 28 and the power line 20. Thus, the coupling circuit 282 will cope with and transmit the signal: the signal passes the transmission interface 280 into the coupling circuit 282, herein implemented as the coupling transformer 2824, and the coupling transformer 2824 couples the signal from/to the high level mixing voltage on the power line 20 to/from a low level safety signal, and the noise filter circuit 2822 filters out the noises, and the detecting circuit 2826 detects the electrical power polarity of the power line 20. The following explains the powerline signal 30 on the power line 20, as shown in FIG. 5a. The powerline signal 30 includes a power signal 30a, shown in FIG. 5b, and a network signal 30b, shown in FIG. 5c, for the computer system 26. The power transmission unit 288 sends the power signal 30a to the power source unit 262 for supplying the computer system 26 with the power, and the coupling circuit 282 couples the network signal 30b to the data-powerline converter 264 for the computer system 26. The data-powerline converter 264 can be a chip mode, that is, the data-powerline converter 264 is configured in a chip, or an interface-card mode, which is configured in an interface card, and electrically connected to a printed circuit board of the computer system 26. When the data-powerline converter 264 is the card mode, it uses an electronic interface to fix it on the printed circuit board, wherein the electronic interface can be a universal serial bus (USB), a peripheral component interconnect (PCI), a peripheral component interconnect express (PCI-E) or an IEEE 1394 interface, and, when the data-powerline converter 264 is the chip mode, it is built in the printed circuit board. Therefore, the power source unit 262 of the computer system 26 will supply the power to the data-powerline converter 264.

In conclusion, an embodiment of this invention uses a powerline network device to connect with a computer system. One end of the powerline network device connects the wire originally used by the computer system as a power line, and another end plugs into the outlet of the computer system via power transmission unit for supplying the computer system with power continuously, and a data-powerline converter is built in the computer system. The data-powerline converter uses a signal-line set to connect with the powerline network device, and the powerline network device couples the powerline signal to the data-powerline converter. Therefore, the data-powerline converter will convert the signal to a network signal, which can be used by the computer system, to reach the homeplug application under a low cost.

Although the present invention has been explained in relation to its preferred embodiments, it is to be understood that other modifications and variation can be made without departing the spirit and scope of the invention as claimed.

What is claimed is:

1. A powerline network device, comprising
a coupling circuit;
a transmission interface connected to said coupling circuit to transmit/receive a powerline signal;
a power transmission unit connected to said coupling circuit; and
a signal-line set electrically connected to said coupling circuit.

2. A powerline network device according to claim 1, wherein said coupling circuit is a coupling transformer.

3. A powerline network device according to claim 1, wherein said transmission interface is a socket, and is electrically connected to a power line to connect said powerline signal.

4. A powerline network device according to claim 1, wherein said coupling circuit further comprises a noise filter unit electrically connected to said power transmission unit.

5. A powerline network device according to claim 1, wherein said coupling circuit further comprises a detecting circuit electrically connected to said transmission interface.

6. A powerline network device according to claim 1, wherein said power transmission unit is an outlet or a wire-added outlet for connecting to a power source unit of a computer system.

7. A powerline network device according to claim 1, wherein said signal-line set comprises at least a twisted pair.

8. A powerline network apparatus, comprising
a powerline network device, comprising:
a coupling circuit;
a transmission interface connected to said coupling circuit to transmit a powerline signal;
a power transmission unit connected to said coupling circuit; and
a signal-line set electrically connected to said coupling circuit; and
a data-powerline converter electrically connected with said signal-line set of said powerline network device, wherein said data-powerline converter is configured to be connected with a computer system.

9. A powerline network apparatus according to claim 8, wherein said coupling circuit is a coupling transformer.

10. A powerline network apparatus according to claim 8, wherein said transmission interface is a socket, which is electrically connected to a power line to connect said powerline signal.

11. A powerline network apparatus according to claim 8, wherein said power transmission unit is connected to a power source unit of said computer system.

12. A powerline network apparatus according to claim 8, wherein said power transmission unit is an outlet or a wire-added outlet.

13. A powerline network apparatus according to claim 8, wherein said coupling circuit further comprises a noise filter unit electrically connected to said power transmission unit.

14. A powerline network apparatus according to claim 13, wherein said coupling circuit further comprises a detecting circuit electrically connected to said transmission interface.

15. A powerline network apparatus according to claim 8, wherein said signal-line set comprises at least a twisted pair.

16. A powerline network apparatus according to claim 8, wherein said data-powerline converter is a chip built in a printed circuit board of said computer.

17. A powerline network apparatus according to claim 8, wherein said data-powerline converter is built in an interface card, and plugged into a printed circuit board of said computer system.

18. A powerline network apparatus according to claim 17, wherein said data-powerline converter comprises an electrical interface for electrically connecting to said printed circuit board of said computer system.

19. A powerline network apparatus according to claim 18, wherein said electrical interface is a universal serial bus (USB), a peripheral component interconnect (PCI), a peripheral component interconnect express (PCI-E) or an IEEE-1394 interface.
